(19) United States
(12) Patent Application Publication
(10) Pub. No.: US 2026/0146670 A1
(43) Pub. Date: May 28, 2026

(54) PARKING LOCK DEVICE

(71) Applicant: VALEO EMBRAYAGES, Amiens Cedex 2 (FR)

(72) Inventors: Gilles LEBAS, Amiens (FR); Pierre PATAUT, Amiens (FR); Roel VERHOOG, Amiens (FR)

(73) Assignee: VALEO EMBRAYAGES, Amiens Cedex 2 (FR)

(21) Appl. No.: 19/399,358

(22) Filed: Nov. 24, 2025

(30) Foreign Application Priority Data
Nov. 25, 2024 (FR) FR2412911

(51) Int. Cl. F16H 63/34

(52) U.S. Cl. CPC F16H 63/3475; F16H 63/3433

(57) ABSTRACT

A parking lock device for a vehicle includes a main actuator of an electromagnetic type and a blocking actuator of an electromagnetic type. The blocking actuator includes a blocking plunger configured on the one hand to cooperate, in at least one blocking position, with the main plunger and on the other hand to disengage from the main plunger in an unlocked position. An anti-rotation device is configured to prevent rotation of the main plunger on itself.

The present invention relates to a parking lock device, in particular for an electric vehicle.

The patent application EP3726099 discloses a parking lock device for a motor vehicle driven by an electric motor. The parking lock device comprises a parking lock wheel which is connected for conjoint rotation to a shaft in the drive train and which has multiple recesses. A locking element is provided which is movable between a closed position and an open position along a movement path and which, in the closed position, engages in a form-fitting manner in a recess in the parking lock wheel and, in the open position, is out of engagement with the recesses in the parking lock wheel. The device further comprises a parking lock actuator which is operatively connected to the locking element and by way of which the locking element is movable between the closed position and the open position along its movement path. Provision is made for the path of the locking element to be rectilinear, for example.

The purpose of a parking lock device of this kind is, in the closed position, to prevent the vehicle from accidentally rolling away while parked.

The aim of the invention is to provide a parking lock device which is simple, and therefore relatively inexpensive, but just as reliable.

The invention thus relates to a parking lock device for a vehicle, in particular for a motor vehicle driven by an electric motor, this parking lock device being able to cooperate with a parking lock wheel which is connected for conjoint rotation to a shaft of a drive train and which has an alternation of teeth and recesses, this parking lock device comprising:
a main actuator of an electromagnetic type, comprising a main plunger configured to be moved in a magnetic field generated by a coil of the main actuator, the main plunger being configured to be moved, along an axis of movement of this main plunger, between an open position, in which the main plunger leaves the wheel disengaged, and a closed position, in which the main plunger causes the wheel to be blocked,
a blocking actuator of an electromagnetic type, comprising a blocking plunger configured to be moved in a magnetic field generated by a coil of the blocking actuator, the blocking plunger being configured on the one hand to cooperate, in at least one blocking position, with the main plunger or an optional lever actuated by the main plunger in order to block this main plunger or this optional lever in particular in the closed position, and on the other hand, in an unlocked position, to disengage from the main plunger or from this optional lever, this optional lever comprising a second finger configured to be moved into a recess in the wheel in order to block the wheel in the closed position of the main plunger, and, when the main plunger is in the open position, the lever leaves the wheel disengaged,
an anti-rotation device configured to prevent rotation of the main plunger on itself.

The use of two actuators of the electromagnetic type, in particular solenoids, has the advantage of reduced cost. This is made possible by the fact that the parking lock device closes only when the vehicle is stationary. The rotational stop also offers an advantage by facilitating mechanical cooperation between the actuating plunger and the blocking plunger.

According to one aspect of the invention, the blocking plunger is configured to cooperate, in two distinct blocking positions, with the main plunger in order to block the latter in its open position and its closed position, respectively.

These two distinct blocking positions comprise in particular a lower position and an upper position of the main plunger.

According to one aspect of the invention, the main plunger comprises first and second shapes, in particular two grooves or two holes, spaced apart along the axis of movement of this main plunger, each shape corresponding to one of the two blocking positions of the blocking plunger on the main plunger. The blocking plunger cooperates with these shapes when the blocking plunger is situated in either of the blocking positions. In particular, the blocking plunger has a head configured to engage in one of these shapes of the main plunger in the blocking position.

According to one aspect of the invention, the anti-rotation device comprises a third shape, in particular a groove, on the main plunger, which third shape is configured to cooperate with a fourth shape of a fixed part, in particular a fixed pin, such that the main plunger is able to be moved by the coil of the main actuator without allowing rotation on itself. Thus, the anti-rotation function may be achieved by the use of shapes between the main plunger and a fixed part belonging for example to a solenoid, a casing supporting the solenoids, or can be an attached rivet. The anti-rotation device can be configured to provide an anti-rotation function over the entire stroke or only over a part of the stroke of movement of this main plunger between its open position and closed position.

According to one aspect of the invention, the anti-rotation device is configured to allow a certain flexibility of the anti-rotation of the order of a few degrees about the axis of movement of the main plunger, for example from 0.5° to 10°, which makes it possible to compensate for defects in the production of the various elements.

According to one aspect of the invention, the main plunger is a rigid one-piece component.

Thus, the main plunger is of a simple and economical design, allowing the shapes associated with the anti-rotation and blocking functions in the lower and/or upper position to be integrated on the same component.

According to one aspect of the invention, when the blocking actuator is not electrically powered, the blocking plunger is itself held in the blocking position by an axial force along an axis of movement of this blocking plunger, the axial force being generated in particular by a spring. When the main plunger is in an indeterminate position, the blocking plunger, if not powered, may wait for the main plunger to slide to its open or closed position before translating to the blocking position.

According to one aspect of the invention, the main plunger comprises a first finger configured to be moved into a recess in the wheel in order to block the wheel in the closed position.

According to one aspect of the invention, the first finger is made in the continuation of a body of the main plunger, in particular of the same material as the body of the main plunger, or the main plunger is formed of several parts made of different materials, the several parts being integral with each other, for example with one material for the electromagnetic part and a different material for the first finger, which must in particular withstand high contact pressures. According to one aspect of the invention, the blocking plunger is formed of several parts made of different materials, the several parts being integral with each other, for example with one material for the electromagnetic part and a different material for the head, which must in particular withstand high contact pressures.

In this embodiment, the main plunger cooperates directly with the wheel.

According to one aspect of the invention, the first finger of the main plunger has a frustoconical shape.

In a variant, the first finger of the main plunger, which is configured to engage on the wheel, has an elongate shape along the axis of rotation of the wheel, this shape being in particular of the prismatic type.

In this case, the anti-rotation device is configured to hold the first finger of elongate shape parallel to the recess in the wheel, which also has a complementary elongate shape.

This prevents the first finger of elongate shape from turning to the right or to the left and becoming misaligned with respect to the recess in the wheel.

Such a misalignment could prevent the first finger from engaging in the recess.

Another advantage of the prismatic shape is that it makes it possible to establish contact between the first finger and the wheel over a relatively large surface area. This reduces the contact pressure, thereby improving the mechanical strength of the assembly.

According to another aspect of the invention, the main plunger is configured to cooperate with a lever that comprises a second finger configured to be moved into a recess in the wheel in order to block the wheel in the closed position of the main plunger, and, when the main plunger is in the open position, the lever leaves the wheel disengaged.

In this case, the main plunger does not cooperate directly with the wheel, but the lever acts as an intermediary between the main plunger and the wheel.

An advantage of this configuration is the creation of a lever arm which, for the same movement of the second finger of the lever, makes it possible to reduce the movement of the main plunger. This permits a reduction in the cost of the solenoid for actuation of the main plunger.

According to one aspect of the invention, the actuating lever allows a lever arm of between 0.5 and 5.

According to one aspect of the invention, the lever has an elongate shape along an axis of elongation, and the lever is configured to be placed with its axis of elongation substantially orthogonal to the axis of rotation of the wheel.

According to one aspect of the invention, the lever has a pivot axis that is configured to be placed substantially parallel to the axis of rotation of the wheel.

Alternatively, the pivot axis of the lever is configured to be placed substantially orthogonal to the axis of rotation of the wheel.

According to one aspect of the invention, the lever has a pivot axis and the main plunger is configured to bear in a central bearing region of the lever, between the pivot axis and the second finger of the lever. According to one aspect of the invention, the second finger is at one end of the elongate shape of the lever.

The stroke of the second finger can determine the stroke of the main plunger by placing it along the lever (or articulated arm). It may be advantageous to increase the lever arm in order to reduce the travel of the main solenoid.

In a variant, the main plunger is configured to bear in an end bearing region of the lever, such that the pivot axis of the lever is between this bearing region and the second finger.

According to one aspect of the invention, the second finger of the lever has a frustoconical shape.

In a variant, the second finger of the lever, which is configured to engage on the wheel, has an elongate shape along the axis of rotation of the wheel, this shape being in particular of the prismatic type.

In this case, the lever is advantageously configured to hold the second finger of elongate shape of the lever parallel to the recess in the wheel, which also has a complementary elongate shape.

This prevents the second finger of elongate shape from turning to the right or to the left and becoming misaligned with respect to the recess in the wheel.

Such a misalignment could prevent the second finger from engaging in the recess.

According to another aspect of the invention, the blocking plunger is configured to cooperate, in the blocking position, with the lever, in particular in a form-fitting manner.

According to one aspect of the invention, the main actuator and/or the blocking actuator are of the normally closed type, i.e. in the absence of electrical power the actuator, if it is the main actuator, tends to move the main plunger to the closed position, or, if it is the blocking actuator, tends to move the blocking plunger to the blocking positions.

According to one aspect of the invention, both the main actuator and the blocking actuator are of the normally closed type.

According to one aspect of the invention, for the main actuator and/or the blocking actuator of the normally closed type, the actuator comprises a spring, in particular an axial spring, which is connected to the plunger and which exerts a permanent mechanical force on the plunger in order to move the latter to the closed position/blocking position.

This mechanical force makes it possible to close the parking lock device by pushing the first finger or the second finger into a recess in the wheel.

With a main actuator of the normally closed type, when at the top of a tooth, the main plunger will be between the two extreme positions, namely between the open position and the closed position, since the wheel is not locked, and the spring makes it possible to memorize the information and wait for the wheel to turn before the device locks.

Thus, it is possible to exit the vehicle after the ignition has been turned off, and the two springs mechanically allow the parking lock device to lock mechanically without the need for an electrical power supply.

This makes it possible to guarantee controlled positions and to do so without unnecessary power consumption.

Alternatively, both the main actuator and the blocking actuator are of the normally open type, i.e. in the absence of electrical power, the actuator, if it is the main actuator, tends to move the main plunger to the open position, or, if it is the blocking actuator, tends to move the blocking plunger to the unlocked position.

According to one aspect of the invention, the first finger or the second finger adapted to be in contact with the teeth of the wheel may have a wedge shape (or “non-disengaging” shape), allowing the wheel to frictionally retain the finger of the main plunger or of the lever in the closed position, in order to avoid mechanically biasing the main plunger and in particular the blocking plunger. The wedge shape is characterized by an angle α of between 0 and 30°, preferably 6°. The angle α is defined between a facet of the first finger or the second finger bearing on the teeth (in particular a plane-on-plane bearing) and the axis of movement of the main plunger.

In a variant, the first finger or the second finger adapted to be in contact with the teeth of the wheel has a wedge shape, and the wedge shape is characterized by an angle α of between 2° and −15°, preferably being equal to 0°. A relatively small angle α, in particular close to 0 or less, for example between 2° and −15°, preferably 0°, will make it possible to avoid opening of the main plunger under the tangential force and will permit disengagement, under slight force, of the blocking plunger (only the frictional forces and dynamic forces associated with the inertia of the blocking plunger) while protecting the blocking plunger from a tangential force that could shear or damage it.

According to one aspect of the invention, the centre of gravity of the lever is on the pivot axis of the lever, so that the centre of gravity of the lever is on a neutral line.

According to one aspect of the invention, the pivot axis is formed by a member of circular external contour, and the centre of gravity of the lever is positioned inside this circular external contour.

This ensures that, if the lever receives an impact or an acceleration, the lever does not start to rotate, which is a safety feature. The positioning of the centre of gravity is thus managed so that the lever is not able to open on its own in the event of an accidental impact.

According to one aspect of the invention, the parking lock device is configured to prevent locking for vehicle speeds above a threshold, in particular a threshold of 4 km/h. It is possible for this to be managed electronically, in particular by means of sensors. The sensors may be sensors of the locking device or, preferably, sensors of the vehicle (other than the locking device).

These sensors make it possible, for example, to know the speed of the vehicle and to know when to lock or not lock.

Each actuator is controlled in position by physical sensors (contactors, Hall effect sensors, etc.) or by indirect control based on physical measurements of the electromagnet of the actuator (current, induction, etc.).

According to one aspect of the invention, the main actuator and the blocking actuator are controlled independently, for example by two different electronic control systems. The control electronics may be located in centralized electronics external to the parking lock device or, alternatively, may be located in the parking lock device itself.

According to one aspect of the invention, the two actuators may be formed by a common module, being placed in particular in the same housing of the common module or being secured to each other to form the common module. It is thus possible to facilitate transport and/or assembly operations.

The invention further relates to a system comprising:
a parking lock wheel which is connected for conjoint rotation to a shaft of a drive train and which has an alternation of teeth and recesses,
a parking lock device as described above, the main plunger of which is to be moved between the open position, in which the main plunger leaves the wheel disengaged, and a closed position, in which the main plunger causes the wheel to be blocked.

According to one aspect of the invention, the system is configured to be mounted in a vehicle driven by an electric motor.

The system may be inside or outside a gearbox reducer housing. The system according to the invention may be sealed against or lubricated by gearbox oil.

The aforementioned module may be mounted inside or outside the housing.

According to one aspect of the invention, the gearbox comprises a gear set comprising an input shaft cooperating with a rotor shaft of the electric motor. The wheel of the system is rotationally connected to the input shaft.

The invention also relates to a gearbox comprising a reducer and a system as mentioned above.

Other features, details and advantages of the invention will become more clearly apparent from reading the following description and from the embodiments that are given by way of non-limiting indication and with reference to the appended schematic drawing, in which:

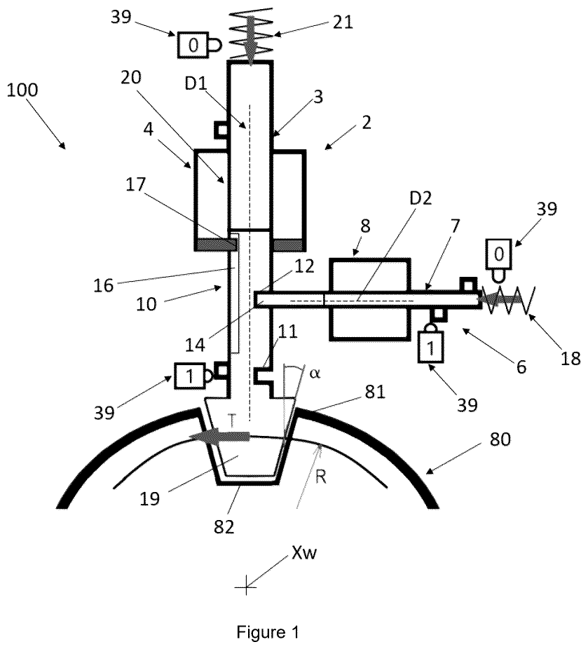

FIG. 1 is a schematic representation of a system according to one example of implementation of the invention;

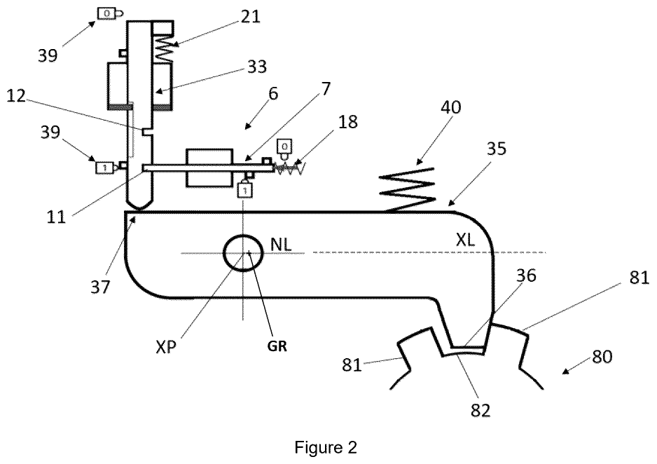

FIG. 2 is a schematic representation of a system according to another example of implementation of the invention;

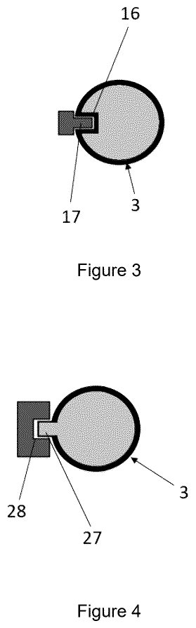

FIG. 3 is a schematic representation of a sectional view of the main plunger of the system in FIG. 1 or FIG. 2, according to an embodiment of the invention;

FIG. 4 is a schematic representation of a sectional view of the main plunger of the system in FIG. 1 or FIG. 2, according to another embodiment of the invention;

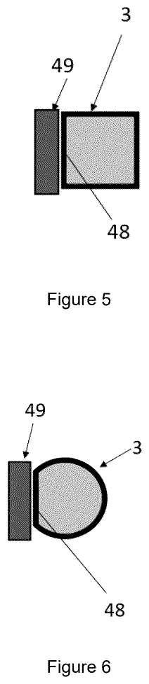

FIG. 5 is a schematic representation of a sectional view of the main plunger of the system in FIG. 1 or FIG. 2, according to another embodiment of the invention;

FIG. 6 is a schematic representation of a sectional view of the main plunger of the system in FIG. 1 or FIG. 2, according to another embodiment of the invention.

The features, variants and various embodiments of the invention may be associated with one another in various combinations, provided that they are not mutually incompatible or mutually exclusive. It will be possible, in particular, to imagine variants of the invention that comprise only a selection of the features described below, in isolation from the other features described, provided that this selection of features is sufficient to confer a technical advantage and/or to distinguish the invention from the prior art.

Furthermore, ordinal numeral adjectives are used to distinguish between features. They do not define the position of a feature. Consequently, for example, a third feature of a product does not mean that the product has a first and/or a second feature.

FIG. 1 shows a system 100 according to an embodiment of the invention, which comprises a parking lock wheel 80 connected for conjoint rotation to a shaft of a drive train (not shown) in a motor vehicle driven by an electric motor.

The parking lock wheel 80 comprises an alternation of teeth 81 and recesses 82, as shown in a simplified manner in FIG. 1 (or as can be seen more clearly in FIG. 2).

The system 100 further comprises a parking lock device 1 as described below.

The system 100 may be inside or outside a housing of a gearbox reducer. The system 100 according to the invention may be sealed against gearbox oil or lubricated by this oil.

The parking lock device 1 comprises a main actuator 2 of the electromagnetic type, comprising a main plunger 3 configured to be moved in a magnetic field generated by a coil 4 of the main actuator 2, the main plunger 3 being configured to be moved, along an axis of movement D1 of this main plunger 3, between an open position, in which the main plunger 3 leaves the wheel 80 disengaged, and a closed position, illustrated in FIG. 1, in which the main plunger 3 causes the wheel 80 to be blocked.

In said open position, the main plunger 3 is raised with respect to the wheel 80 and is not in contact with the wheel 80.

The parking lock device 1 further comprises a blocking actuator 6 of the electromagnetic type, comprising a blocking plunger 7 configured to be moved in a magnetic field generated by a coil 8 of the blocking actuator 6, the blocking plunger 7 being configured on the one hand to cooperate, in at least one blocking position, with the main plunger 3 in order to block the latter in particular in its closed position, and, on the other hand, in an unlocked position, to disengage from the main plunger 3. The main plunger 3 and the blocking plunger 7 are oriented orthogonally.

The parking lock device 1 further comprises an anti-rotation device 10 configured to prevent rotation of the main plunger 3 on itself.

In the example described, the blocking plunger 7 is configured to cooperate, in two distinct blocking positions, with the main plunger 3 in order to block the latter respectively in its open position and its closed position illustrated in FIG. 1.

These two distinct blocking positions comprise a lower position, which corresponds to the closed position, and an upper position (or raised position), which corresponds to the open position of the main plunger 3.

The main plunger 3 comprises a first shape 11 and a second shape 12, which are defined here by two grooves spaced apart along the axis of movement D1 of this main plunger 3. In another embodiment (not shown), the first and second shapes are holes.

The first shape 11 corresponds to one of the two blocking positions of the blocking plunger 7 on the main plunger 3, namely the upper position (or raised position) or the lower position of the main plunger 3.

The second shape 12 corresponds to the lower or closed position of the main plunger 3.

The blocking plunger 7 comprises a head 14 configured to engage in one or other of these shapes 11, 12 of the main plunger 3 in the blocking positions.

As is illustrated in FIG. 3, the anti-rotation device 10 comprises a groove 16 (also designated as “third shape”) on the main plunger 3, here of circular cross section, configured to cooperate with a fourth shape 17 of a fixed part, here a pin, in such a way that the main plunger 3 is able to be moved by the coil 4 of the main actuator 2 without allowing rotation on itself.

In a variant, as illustrated in FIG. 4, the main plunger 3 comprises a projection 27 which cooperates with a slot 28 on the fixed part.

In another variant, as illustrated in FIG. 5, the main plunger 3 may have a cross section with a straight side 48 which cooperates with a block shape 49 on the fixed part. In this example, the cross section is rectangular or square. A clearance between the straight side 48 and the shape 49 makes it possible to compensate for positioning defects.

In another variant, as illustrated in FIG. 6, the main plunger 3 may have a cross section with a straight side 48 on a cross section which is circular beyond the straight side 48.

Thus, the main plunger 3 is a one-piece rigid component comprising both the first shape 11 and/or the second shape 12 for the function of blocking in the upper and/or lower position, and a third shape 16, 27, 48 for the anti-rotation function.

When the blocking actuator 6 is not electrically powered, the blocking plunger 7 is itself held in the blocking position by an axial force along an axis of movement D2 of this blocking plunger 7 (which is perpendicular to the axis of movement D1 of the main plunger 3), the axial force being generated in particular by a second spring 18. When the main plunger 3 is in an indeterminate position, the blocking plunger 7, if not powered, may wait for the main plunger 3 to slide towards its open or closed position before translating into the blocking position.

The main plunger 3 comprises a first finger 19 configured to be moved into a recess 82 in the wheel 80 in order to block the wheel 80 in the closed position.

The first finger 19 is formed in the continuation of a body 20 of the main plunger 3.

The main plunger 3 is formed of several parts made of different materials, the parts being integral with each other, for example with one material for the electromagnetic part and a different material for the first finger 19, which must in particular withstand high contact pressures.

Similarly, the blocking plunger 7 is formed of several parts made of different materials, for example with one material for the electromagnetic part and a different material for the head 14, which must in particular withstand high contact pressures.

In this embodiment in FIG. 1, the main plunger 3 cooperates directly with the wheel 80.

In the example described, the first finger 19 of the main plunger 3 has an elongate shape along the axis of rotation Xw of the wheel 80, this shape of the first finger 19 being in particular of the prismatic type.

In this case, the anti-rotation device 10 is configured to hold the first finger 19 parallel to the recess 82 in the wheel 80, which also has a complementary elongate shape.

This prevents the first finger 19 of elongate shape from turning to the right or to the left and becoming misaligned with respect to the recess 82 in the wheel 80.

Such a misalignment could prevent the first finger 19 from engaging in the recess 82.

In the example described, the main actuator 2 and the blocking actuator 6 are of the normally closed type, i.e. in the absence of electrical power the actuator, if it is the main actuator 2, tends to move the main plunger 3 to the closed position, and, if it is the blocking actuator 6, tends to move the blocking plunger 7 to the locking positions.

For the main actuator 2 and the blocking actuator 6 of the normally closed type, the main actuator 2 comprises a first spring 21, and the blocking actuator 6 comprises a second spring 18, each of which is an axial coil spring, each spring being connected to the plunger and exerting a permanent mechanical force on the respective plunger 3, 7 with a view to moving the latter to the closed position/blocking position.

This mechanical force makes it possible to close the parking lock device 1 by pushing the first finger 19 into a recess 82 in the wheel 80.

With a main actuator 2 of the normally closed type, when located at the top of a tooth 81, the main plunger 3 will be located between the two extreme positions, namely between the open position and the closed position, since the wheel 80 is not locked, and the first spring 21 makes it possible to memorize the inshape and wait for the wheel 80 to turn so that the device 1 locks.

Thus, it is possible to exit the vehicle after the ignition has been switched off, and the two springs 21 and 18 enable the parking lock device 1 to lock mechanically without the need for electrical power supply.

This makes it possible to guarantee controlled positions and to do so without unnecessary power consumption.

The first finger 19 which comes into contact with the teeth 81 of the wheel 80 may be wedge-shaped (in particular a prismatic shape with a trapezoidal cross section), making it possible to eject the first finger 19 of the main plunger 3 when the blocking plunger 7 is not in the blocking position. The wedge shape is characterized by an angle α of between 0 and 30°, preferably 6°. The angle α is defined between a facet of the finger bearing on the teeth 81 (in particular a plane-on-plane bearing) and the axis of movement D1 of the main plunger 3.

In a variant, a relatively small angle α, in particular close to 0 or less, for example between 2° and −15°, preferably 0°, will make it possible to prevent the main plunger 3 from opening under the tangential force T and will allow the blocking plunger 7 to disengage under low force (only the frictional forces and the dynamic forces associated with the inertia of the blocking plunger 7) while protecting the blocking plunger 7 from a tangential force that could shear or damage it.

In another embodiment of the invention illustrated in FIG. 2, the main plunger 33 is configured to cooperate with a lever 35 which comprises a second finger 36 to be moved into a recess 82 in the wheel 80 in order to block the wheel 80 in the closed position of the main plunger 33, and, when the main plunger 33 is in the open position, the lever 35 leaves the wheel 80 disengaged.

In this case, the main plunger 3 does not cooperate directly with the wheel 80, but the lever 35 serves as an intermediary between the main plunger 3 and the wheel 80.

The lever 35 has an elongate shape along an axis of elongation XL, and the lever 35 is configured to be placed with its axis of elongation XL substantially orthogonal to the axis of rotation Xw of the wheel 80.

The lever 35 has a pivot axis XP which is configured to be placed substantially parallel to the axis of rotation Xw of the wheel 80.

The main plunger 33 is configured to come to bear in an end bearing region 37 of the lever 35, so that the pivot axis XP of the lever 35 is between this bearing region 37 and the second finger 36. The main plunger 33 is able to push or pull the lever in the end bearing region 37 of the lever 35.

In this example in FIG. 2, the first spring 21 of the main actuator 2 is placed on one side of the main plunger 33. This first spring 21 is configured to return the main plunger 33 to the closed position.

An additional spring 40 is connected to the lever 35 in a region opposite the end bearing region 37, to contribute to returning the lever 35 to the closed position.

In a variant, the additional spring 40 could be at the end bearing region 37 and could push on the underside of the lever 35.

In the example in FIG. 2, unlike the example in FIG. 1, when the main plunger 33 is in the upper position, the wheel 80 is locked, and, when the main plunger 33 is in the lower position, the wheel 80 is disengaged.

The second finger 36 of the lever 35, which is configured to engage on the wheel 80, has an elongate shape along the axis of rotation Xw of the wheel 80, this shape being in particular of the prismatic type.

In this case, the lever 35 is advantageously configured to hold the second finger 36 of elongate shape of the lever 35 parallel to the recess 82 in the wheel 80, which also has a complementary elongate shape.

This prevents the second finger 36 of elongate shape from turning to the right or to the left and becoming misaligned with respect to the recess 82 in the wheel 80.

Such a misalignment could prevent the finger from engaging in the recess 82.

The centre of gravity GR of the lever 35 is on the pivot axis XP of the lever 35, so that the centre of gravity GR of the lever 35 is on a neutral line NL.

This ensures that, if the lever 35 receives an impact or an acceleration, the lever 35 does not start to rotate, which is a safety feature. The placement of the centre of gravity GR is thus managed so that the lever 35 is unable to deploy on its own in the event of an accidental impact or an acceleration.

The parking lock device 1 is configured to prevent locking for vehicle driving speeds above a threshold, in particular a threshold of 4 km/h. It is possible for this to be managed electronically, by virtue of sensors. The sensors may be sensors of the locking device or, preferably, sensors of the vehicle (other than the locking device).

These sensors make it possible, for example, to know the speed of the vehicle and to know when to lock or not lock.

Each actuator 2, 6 is controlled in position by physical sensors such as contactors 39, illustrated in FIGS. 1 and 2, which detect the ends of travel of the plungers.

As a variant, the actuators 2, 6 are controlled in position by indirect control based on physical measurements of the electromagnet of the actuator (current, induction, etc.).

For example, the main actuator 2 and the blocking actuator 6 are controlled independently, for example by two different electronic control systems. The control electronics may be located in centralized electronics external to the parking lock device 1 or, as a variant, may be located in the parking lock device 1 itself.

The shaft of the drive train is for example a shaft of an electric machine rotor, a shaft of a reducer or a differential.

1. A parking lock device for a vehicle, in particular for a motor vehicle driven by an electric motor, this parking lock device being able to cooperate with a parking lock wheel which is connected for conjoint rotation to a shaft of a drive train and which has an alternation of teeth and recesses, and this parking lock device comprising:
a main actuator of an electromagnetic type, comprising a main plunger configured to be moved in a magnetic field generated by a coil of the main actuator, the main plunger being configured to be moved, along an axis of movement of this main plunger, between an open position, in which the main plunger leaves the wheel disengaged, and a closed position, in which the main plunger causes the wheel to be blocked,
a blocking actuator of an electromagnetic type, comprising a blocking plunger configured to be moved in a magnetic field generated by a coil of the blocking actuator, the blocking plunger being configured on the one hand to cooperate, in at least one blocking position, with the main plunger or an optional lever actuated by the main plunger in order to block this main plunger or this optional lever in particular in the closed position, and on the other hand, in an unlocked position, to disengage from the main plunger or from this optional lever, this optional lever having a second finger configured to be moved into a recess in the wheel in order to block the wheel in the closed position of the main plunger, and, when the main plunger is in the open position, the lever leaves the wheel disengaged,
an anti-rotation device configured to prevent rotation of the main plunger on itself.

2. The device according to claim 1, wherein the blocking plunger is configured to cooperate, in two distinct blocking positions, with the main plunger in order to block the latter in its open position and its closed position, respectively, wherein in particular these two distinct blocking positions comprise in particular a lower position and an upper position of the main plunger.

3. The device according to claim 2, wherein the main plunger comprises first and second shapes, in particular two grooves or two holes, spaced apart along the axis of movement of this main plunger, each shape corresponds to one of two blocking positions of the blocking plunger on the main plunger, and the blocking plunger cooperates with these shapes when the locking plunger is located in either of the blocking positions.

4. The device according to claim 1, wherein the anti-rotation device comprises a third shape, in particular a groove, on the main plunger, which third shape is configured to cooperate with a fourth shape of a fixed part, in particular a fixed pin, so that the main plunger can be moved by the coil of the main actuator without allowing rotation on itself.

5. The device according to claim 1, wherein, when the blocking actuator is not electrically powered, the blocking plunger is itself held in the blocking position by an axial force along an axis of movement of this blocking plunger, the axial force being generated in particular by a spring.

6. The device according to claim 1, wherein the main plunger comprises a first finger configured to be moved into a recess in the wheel in order to block the wheel in the closed position.

7. The device according to claim 6, wherein the first finger of the main plunger, which is configured to engage on the wheel, has an elongate shape along the axis of rotation of the wheel, this shape being in particular of the prismatic type.

8. The device according to claim 1, wherein the main plunger is configured to cooperate with a lever that comprises a second finger configured to be moved into a recess in the wheel in order to block the wheel in the closed position of the main plunger, and, when the main plunger is in the open position, the lever leaves the wheel disengaged, and in particular the lever has an elongate shape along an axis of elongation and the lever is configured to be placed with its axis of elongation substantially orthogonal to the axis of rotation of the wheel.

9. The device according to claim 8, wherein the lever has a pivot axis and the main plunger is configured to bear in an end bearing region of the lever, so that the pivot axis of the lever is between this bearing region and the second finger.

10. The device according to claim 6, wherein the first finger or the second finger adapted to be in contact with the teeth of the wheel has a wedge shape, and the wedge shape is characterized by an angle α of between 0 and 30°, preferably 6°, the angle α being defined between a facet of the finger bearing on the teeth and the axis of movement of the main plunger.

11. The device according to claim 6, wherein the first finger or the second finger adapted to be in contact with the teeth of the wheel has a wedge shape, and the wedge shape is characterized by an angle α of between 2° and −15°, preferably being equal to 0°.

12. The device according to claim 1, wherein the main actuator and/or the blocking actuator are of the normally closed type, i.e. in the absence of electrical power the actuator, if it is the main actuator, tends to move the main plunger to the closed position, or, if it is the blocking actuator, tends to move the blocking plunger to the blocking positions.

13. The device according to claim 1, wherein the two actuators are formed by a common module, in particular being placed in the same housing of the common module or being joined together to form the common module.

14. A system comprising:
a parking lock wheel which is connected for conjoint rotation to a shaft of a drive train and which has an alternation of teeth and recesses,
a parking lock device according to claim 1, the main plunger of which is to be moved between the open position, in which the main plunger leaves the wheel disengaged, and a closed position, in which the main plunger causes the wheel to be blocked.

15. A gearbox comprising a reducer and a system according to claim 14.

16. The device according to claim 2, wherein the anti-rotation device comprises a third shape, in particular a groove, on the main plunger, which third shape is configured to cooperate with a fourth shape of a fixed part, in particular a fixed pin, so that the main plunger can be moved by the coil of the main actuator without allowing rotation on itself.

17. The device according to claim 2, wherein, when the blocking actuator is not electrically powered, the blocking plunger is itself held in the blocking position by an axial force along an axis of movement of this blocking plunger, the axial force being generated in particular by a spring.

18. The device according to claim 2, wherein the main plunger comprises a first finger configured to be moved into a recess in the wheel in order to block the wheel in the closed position.

19. The device according to claim 2, wherein the main plunger is configured to cooperate with a lever that comprises a second finger configured to be moved into a recess in the wheel in order to block the wheel in the closed position of the main plunger, and, when the main plunger is in the open position, the lever leaves the wheel disengaged, and in particular the lever has an elongate shape along an axis of elongation, and the lever is configured to be placed with its axis of elongation substantially orthogonal to the axis of rotation of the wheel.

20. The device according to claim 7, wherein the first finger or the second finger adapted to be in contact with the teeth of the wheel has a wedge shape, and the wedge shape is characterized by an angle α of between 0 and 30°, preferably 6°, the angle α being defined between a facet of the finger bearing on the teeth and the axis of movement of the main plunger.
